(19) United States
(12) Patent Application Publication
(10) Pub. No.: US 2018/0024624 A1
(43) Pub. Date: Jan. 25, 2018

(54) COMPUTER ANALYSIS OF USER COMFORT IN VIRTUAL REALITY ENVIRONMENTS

(71) Applicant: IMMERSV, INC., PALO ALTO, CA (US)

(72) Inventors: JOHN CHARLES GENTILIN, CASTRO VALLEY, CA (US); MIHIR SHAH, PALO ALTO, CA (US); ANDREW RAYMOND BUCK, SUNNYVALE, CA (US); JONATHAN LINSNER, SAN LEANDRO, CA (US); MARC ANTHONY BOURGET, SAN FRANCISCO, CA (US); ROBERT CARROLL, SAN DIEGO, CA (US)

(21) Appl. No.: 15/214,427

(22) Filed: Jul. 19, 2016

(51) Int. Cl. G06F 3/01; G06F 17/30; G06F 3/0482

(52) U.S. Cl. CPC G06F 3/012; G06F 3/0482; G06F 17/30979; G06F 17/30958

(57) ABSTRACT

A method and apparatus for assessing comfort levels associated with user experience of a virtual reality environment is provided. In an embodiment, during execution of a virtual reality program by a client computer that causes generating and displaying a virtual reality environment via a virtual reality display device that is coupled to the client computer, a set of comfort level processing instructions are programmed to perform receiving a programmatic call from the virtual reality program that invokes comfort level processing; generating and causing the client computer to display a prompt panel within the virtual reality environment that prompts selecting a comfort value indicating a relative level of user comfort associated with the virtual reality environment; receiving an input signal indicating a selection of the comfort value; creating in memory of the client computer a digital message that includes the comfort value, one or more names of metadata attributes associated with the virtual reality environment, and one or more metadata values corresponding to the names of metadata attributes and indicating one or more aspects of a state of the virtual reality environment at a time that the digital message is created; transmitting the digital message from the client computer to a server computer over a data network.

### FIELD OF THE DISCLOSURE

The present disclosure generally relates to the field of computer-based virtual reality systems and applications. Specifically, the present disclosure relates to digitally programmed logic for measuring user comfort during the use of virtual reality environments for displaying content using head-mounted displays and other digital display devices, associating reports of user comfort levels with virtual reality environment state data, and computer-generated analysis that correlates comfort level values to state values in virtual reality environments.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Computer-based virtual reality devices provide a unique immersive experience for a user. Through virtual reality applications, a user is capable of experiencing a fully modeled three dimensional world of a game or movie as if the user was actually in the game or movie. Virtual reality computer systems typically comprise a programmed digital computer coupled, directly or indirectly via networks, to a display device that is capable of rendering a virtual 3D world or environment on a two-dimensional display panel. In some cases the display device may be a head mounted display (HMD) consisting of a wearable apparatus having one or more displays that can be positioned close to the eyes of the user.

HMDs provide an immersive virtual reality experience for a user. Immersion in the visual experience is achieved in part because the HMD displays video across the entire frontal and peripheral visual field of the user so that the real external environment is not seen. An HMD creates the immersive feel by allowing an application publisher to provide a hands free immersion into video games or 3D filmed content. By tracking the orientation and movement of the headset in three dimensions through one or more position/motion detecting chips, an HMD is capable of displaying the 3D environment in a manner that synchronizes with the motion of a person's head. Thus, as a person turns or rotates their head, the headset is capable of recognizing the motion and displaying to the user a corresponding portion of the virtual reality environment.

Unfortunately, some virtual reality environments can have the effect of discomfort on the user after a period of time. For example, the inventors have found that the use of some third party virtual reality environments with immersive HMDs, for periods as short as 20 minutes, can cause discomforting effects such as disorientation, nausea, and fatigue for periods of several hours after use of the virtual reality experience ends. As virtual reality applications become more available to the public, it becomes more important for publishers of virtual reality environments to understand when and how their software, applications and environments are causing discomfort among users.

### SUMMARY

The appended claims may serve to summarize the present disclosure.

### BRIEF DESCRIPTION OF THE DRAWINGS

In the drawings:

FIG. 1 illustrates an example network upon which embodiments may be implemented.

FIG. 2 illustrates an example of a head mounted display for displaying virtual reality applications.

FIG. 3A illustrates a flow diagram of an example method of generating electronic digital messages that carry state metadata for virtual reality environments and values indicating levels of comfort in experiencing virtual reality environments.

FIG. 3B illustrates other steps in the example of FIG. 3A.

FIG. 4 illustrates a flow diagram of an example method of generating analytics data based upon state metadata for virtual reality environments and associated or correlated values indicating levels of comfort in experiencing virtual reality environments.

FIG. 5 is a block diagram of an example computer system with which embodiments can be used, focused on functional elements and data structures that may be configured or programmed to generate messages and analytics data based upon state metadata for virtual reality environments and associated or correlated values indicating levels of comfort in experiencing virtual reality environments.

FIG. 6 is a block diagram that illustrates a computer system upon which an embodiment may be implemented.

### DETAILED DESCRIPTION

In the following description, for the purposes of explanation, numerous specific details are set forth in order to provide a thorough understanding of the present disclosure. It will be apparent, however, that embodiments may be practiced without these specific details. In other instances, well-known structures and devices are shown in block diagram form in order to avoid unnecessarily obscuring the present disclosure. Embodiments are disclosed in sections according to the following outline:

1. GENERAL OVERVIEW

2. STRUCTURAL OVERVIEW

3. INVOKING COMFORT-LEVEL PROCESSING IN A VIRTUAL REALITY ENVIRONMENT

4. ANALYTICS PROCESSING

5. IMPLEMENTATION EXAMPLE—HARDWARE OVERVIEW

1. General Overview

Maintaining user comfort in a virtual reality experience or environment has become a significant issue. Many virtual reality environments are supported via the internet, using computer-implemented techniques in which a server computer stores, for downloading to client computers, sets of instructions that the client computers can use to render a virtual reality environment, provide a virtual reality game, or provide other virtual reality experiences. Because the publishers of virtual reality environments are separated from client computers, head-mounted displays, and end users by the internet, the publishers face an internet-specific problem of how to obtain meaningful data about the level of user comfort during a particular virtual reality experience, and also how to concurrently obtain information about a virtual position, location, level or other state of the client computers, head-mounted displays, and end users at the time that an event of comfort or discomfort occurred.

As a solution, the disclosure herein provides computer-implemented techniques that may be used, for example, to poll a client computer by providing a panel of multiple choices or options directed at how the user feels at a particular time. The poll or prompt to the client computer may occur at a particular interval in a game, a particular location within a virtual reality environment, or in association with a specified object that is shown in the virtual reality environment. In one embodiment, if the client computer responds with input indicating a level of discomfort that is below a specified minimum threshold level, then the techniques herein are programmed to present a secondary prompt to request more particularized information.

Response data, including input specifying a comfort level, the particularized information about discomfort, if available, and one or more metadata values associated with the then-current state of the virtual reality environment, are stored. Storage may comprise storing locally in the client computer and/or transmitting to a server computer, which may store the response data values in a database. In some embodiments, the stored data is reported back to the publisher of the virtual reality environment.

In an embodiment, the publisher of the virtual reality environment can cause reports of the response data to be tagged with metadata that has particular utility to the publisher, and multiple different publishers of different virtual reality environments can arrange reports that use different metadata values. Examples of metadata values include a level within the virtual reality environment and then-currently associated with the client computer, user, or user account; status of a user, user account, or client computer; items that the user, user account, or client computer has virtually acquired, obtained or won in the virtual reality environment; geolocation in the virtual environment; or even complete state data for a game or other virtual reality environment such as time of the session. In addition to discrete state values, the metadata values can define or specify major events that occurred for the user, user account, or client computer in the virtual reality environment. Metadata values also may indicate achievements since a past update to the metadata values.

In an embodiment, analytics instructions programmed at a server computer may report, graph or chart particular comfort level values in association with particular metadata values. As a simplified example, a report may indicate the aggregated comfort level values that a large number of users have inputted at a particular level in a virtual reality game.

Aspects of the disclosure generally relate to computer implemented techniques for generating a virtual reality environment for displaying content. In an embodiment, a method and apparatus for assessing comfort levels associated with user experience of a virtual reality environment is provided. In an embodiment, during execution of a virtual reality program by a client computer that causes generating and displaying a virtual reality environment via a virtual reality display device that is coupled to the client computer, a set of comfort level processing instructions are programmed to perform receiving a programmatic call from the virtual reality program that invokes comfort level processing; generating and causing the client computer to display a prompt panel within the virtual reality environment that prompts selecting a comfort value indicating a relative level of user comfort associated with the virtual reality environment; receiving an input signal indicating a selection of the comfort value; creating in memory of the client computer a digital message that includes the comfort value, one or more names of metadata attributes associated with the virtual reality environment, and one or more metadata values corresponding to the names of metadata attributes and indicating one or more aspects of a state of the virtual reality environment at a time that the digital message is created; transmitting the digital message from the client computer to a server computer over a data network.

2. Structural Overview

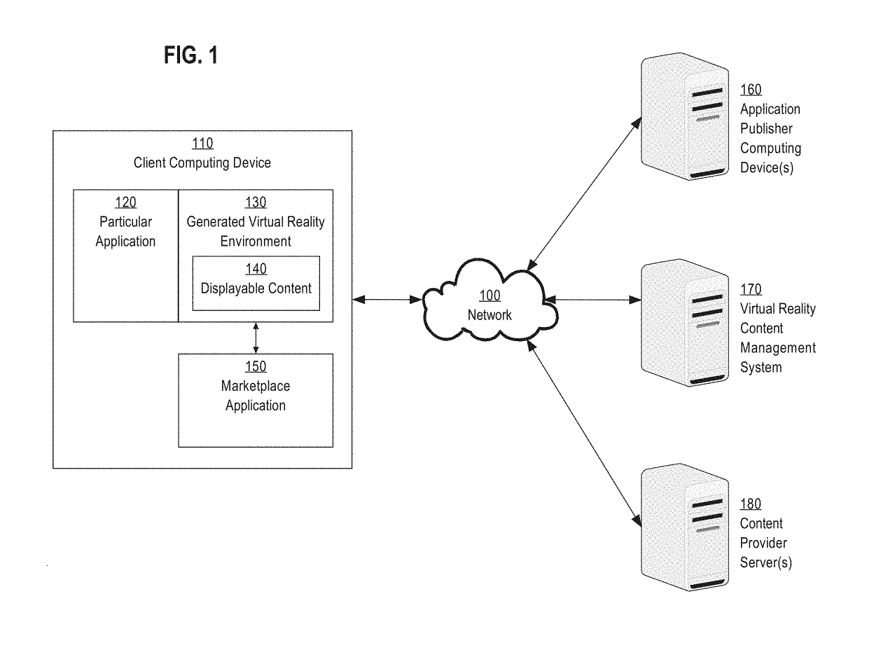

FIG. 1 illustrates an example network upon which embodiments may be implemented. FIG. 1 comprises client computing device 110, application publisher computing device(s) 160, and virtual reality analytics system 170, which are communicatively coupled over network 100.

Network 100 may be implemented by any medium or mechanism that provides for the exchange of data between the various elements of FIG. 1. Examples of network 100 include, without limitation, one or more networks, such as one or more Local Area Networks (LANs), one or more Wide Area Networks (WANs), one or more Ethernets or the Internet, or one or more terrestrial, satellite or wireless links. For purposes of illustrating a clear example, network 100 is shown as a single element, but in practice network 100 may comprise one or more local area networks, wide area networks, and/or internetworks. The various elements of FIG. 1 may also have direct (wired or wireless) communications links, depending upon a particular implementation.

Each of application publisher computing device(s) 160 and virtual reality analytics system 170 may be implemented using a server-class computer or other computer having one or more processor cores, co-processors, or other computers. FIG. 1 depicts client computing device 110, application publisher computing device(s) 160, and virtual reality analytics system 170 as distinct elements for the purpose of illustrating a clear example. However, in other embodiments more or less server computers may accomplish the functions described herein. For example, virtual reality analytics system 170 may interact with a plurality of application publisher computing devices 160 and/or a plurality of client computing devices 110. As another example, a single server computer may perform the functions of application publisher computing device(s) 160. Additionally, application publisher computing devices 160 may be one or more of a smart phone, PDA, tablet computing device, laptop computer, desktop computer, workstation, or any other computing device capable of transmitting and receiving information and performing the functions described herein.

Client computing device 110 may be any computing device that is capable of displaying a virtual reality environment and interacting over a network with virtual reality analytics system 170. Client computing device may be a smart phone, personal computer, tablet computing device, PDA, laptop, or any other computing device capable of transmitting and receiving information and performing the functions described herein. In an embodiment, client computing device is a head mounted display for displaying virtual reality applications. Additionally and/or alternatively, client computing device may be communicatively coupled to a head mounted display for displaying virtual reality applications. For example, a head mounted display may be communicatively coupled to a personal computer which performs the receiving and transmitting functions described herein and further causes displaying, through the head mounted display, a virtual reality application.

In an embodiment, client computing device 110 executes a particular application 120, which may be a virtual reality display, virtual reality game, modified reality display, modified reality game, 360 degree video, or 3D video, as some examples. Client computing device 110 may receive particular application 120 from application publisher computing device(s) 160 over network 100. Additionally and/or alternatively, particular application 120 may execute on client computing device 110 from one or more computer readable media storing instructions which, when executed by client computing device 110, cause client computing device 110 to execute the particular application.

In an embodiment, client computing device 110 executes the generated virtual reality environment 130. Client computing device 110 may receive the generated virtual reality environment 130 from virtual reality analytics system 170 over network 100. Additionally and/or alternatively, client computing device 110 may receive the generated virtual reality environment 130 from application publisher computing device(s) 160 and/or from one or more computer readable media storing instructions which, when executed by client computing device 110, cause client computing device 110 to execute the generated virtual reality environment 130.

In an embodiment, the generated virtual reality environment 130 contains displayable content 140. Displayable content 140 may include a two dimensional video, a two dimensional game or game demonstration, a three dimensional video, a 360 degree video, a virtual reality game or game demonstration, and/or a three dimensional game or game demonstration, as some examples, in various embodiments. In an embodiment, client computing device 110 receives displayable content 140 from virtual reality analytics system 170 over network 100 with virtual reality environment 130. Additionally and/or alternatively, client computing device 110 may initially receive or execute virtual reality environment 130 and receive displayable content 140 from virtual reality analytics system 170 upon loading or execution of virtual reality environment 130.

In an embodiment, client computing device 110 additionally executes a marketplace application 150. Marketplace application 150 may interact with application programming interfaces (APIs) of application publisher computing device(s) 160 over network 100 to cause additional applications to be downloaded from application publisher computing device(s) 160 to client computing device 110. In an embodiment, the generated virtual reality environment 130 contains instructions which, when executed by the client computing device 110, causes the client computing device to execute the marketplace application 150 and navigate to an application hosted by application publisher computing device(s) 160 and associated with displayable content 140. The instructions may also cause client computing device 110 to download and install the application hosted by application publisher computing device(s) 160 through the marketplace application.

Application publisher computing device(s) 160 is communicatively coupled to virtual reality analytics system 170 via one or more networks, which may be implemented in the manner previously described for network 100. Application publisher computing device(s) may be configured to send design data to virtual reality analytics system 170 over network 100. Additionally, application publisher computing device(s) 160 may be further configured to provide particular application 120 to client computing device 110 over network 100.

Virtual reality analytics system 170 is communicatively coupled to application publisher computing device(s) 160 and client computing device 110. Virtual reality analytics system 170 may be configured to receive design data from application publisher computing device(s) 160 and cause display of generated virtual reality environment 130 on client computing device 110 over network 100. In an embodiment, virtual reality analytics system 170 is configured to generate virtual reality environments for displaying content, modify virtual reality environments with design data, and insert particular content into the virtual reality environment. While virtual reality analytics system 170 is depicted as one server computing device, in an embodiment multiple server computers perform the functions described herein. For example, a first server computer may interact with application publisher computing device(s) 160 to generate a virtual reality environment while a second server computer may interact with client computing device 110 to cause display of the virtual reality environment with particular content.

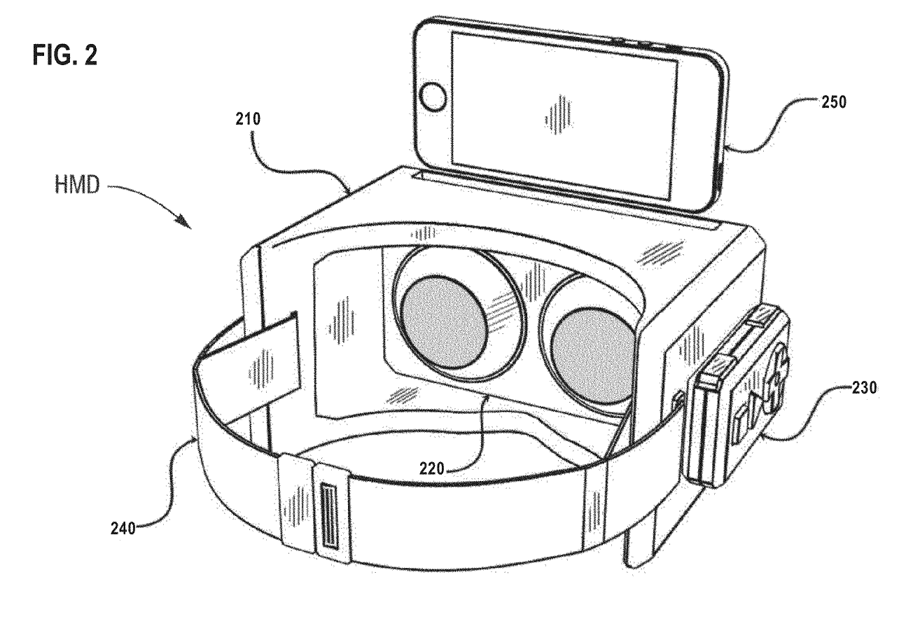

FIG. 2 illustrates an example of a head mounted display for displaying virtual reality applications. While FIG. 2 depicts an example head mounted display which utilizes a smartphone, the systems and methods described herein may also be applied to head mounted displays and other versions of generating virtual reality environments that do not rely on a smartphone device. For example, the methods described herein may be performed using premanufactured head mounted displays, such as the OCULUS RIFT.

The device of FIG. 2 comprises a main body 210 which may be fitted with a lens assembly 220, a strap 240 which securely attaches the main body to the user's a head, a re-attachable remote controller 230, and an external mobile computing device 250 to be secured in the main body. The main body 210 as disclosed herein may be easily adapted to fit any of a number of mobile computing device 250 shapes and sizes, such as, but not limited to, the SAMSUNG GALAXY 4, the IPHONE 5, and the HTC ONE. As noted, strap 240 in FIG. 2 may be used to securely attach the main body to the user's head, but other or additional means and methods may be used. For example, main body 210 could be incorporated into a helmet-like device which is secured to the top a user's head without a strap. The device may also include other means of interacting with the mobile computing device within such as one or more levers coupled to a stylus which is configured to be incident on a touch screen of the mobile computing device or one or more holes in the device through which a user may interact with the mobile computing device.

External mobile computing device 250 may include a central processing unit (CPU), a screen, and wireless communication functionality. External mobile computing device 250 may be capable of running applications for use with the head mounted device. External mobile computing device 250 may incorporate one or more motion sensors, for example, gyroscopes, gravitometers, magnetometers, accelerometers, and similar sensors, which may be relied upon, at least in part, in determining the orientation and movement of the overall head mounted display. In some embodiments, one or more additional sensors are located on main body 210, such as light or pressure sensors which are used to determine whether the head mounted display is being worn by a user.

Lens assembly 220 may be configured to allow three dimensional display through a particular screen. For example, each lens of lens assembly 220 may be configured to focus on a different portion of the mobile computing device screen. The mobile computing device 110 may display a stereoscopic image by displaying a left portion of a stereoscopic image on a left portion of the screen of the mobile computing device 110 and a right portion of the stereoscopic image on a right portion of the screen of the mobile computing device. By displaying slightly different images to each eye, the device allows creation and display of virtual reality, modified reality, 360 degree video, and 3D video.

3. Invoking Comfort Level Processing in a Virtual Reality Environment

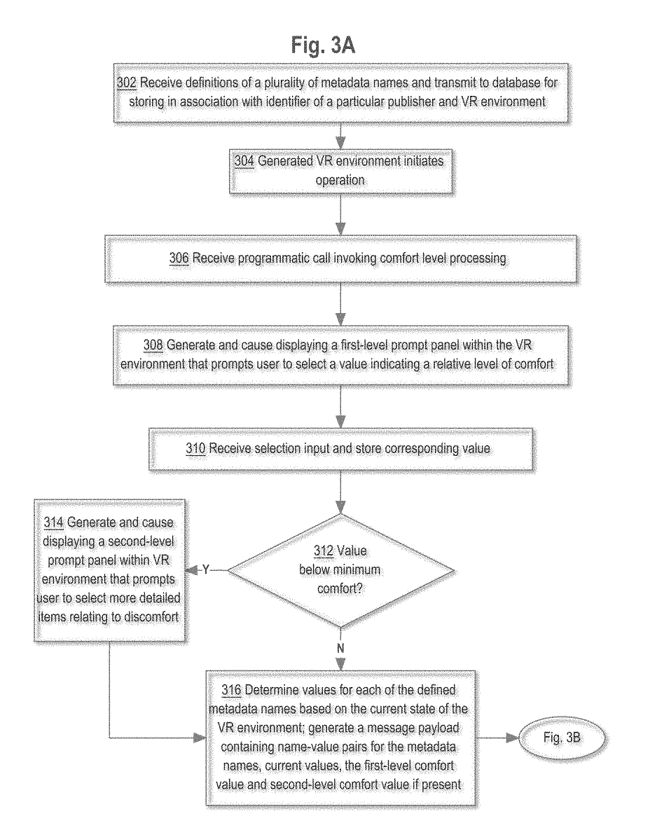

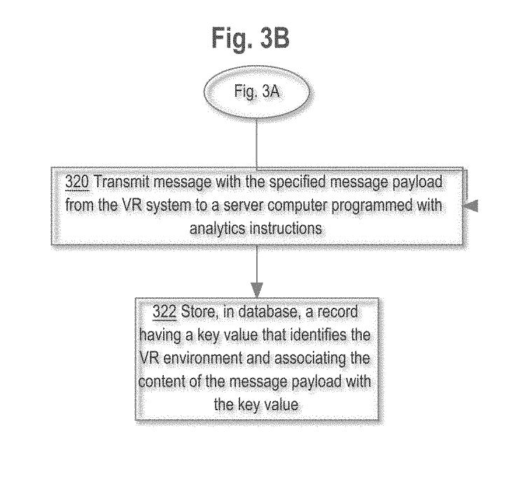

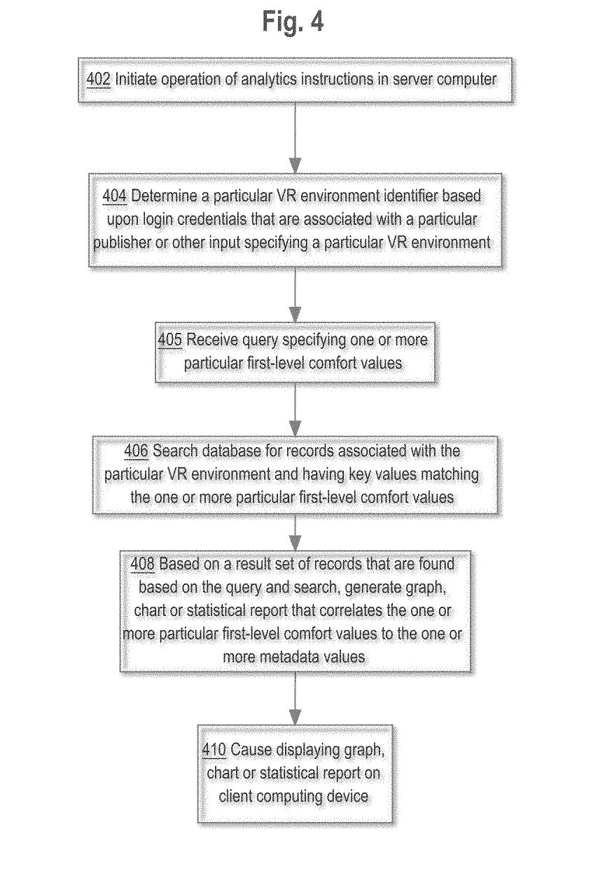

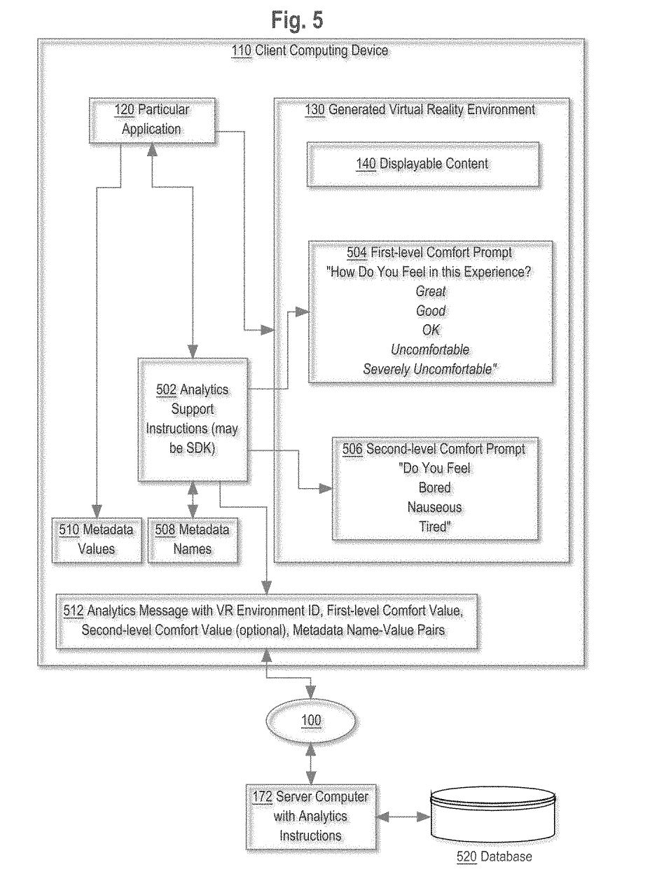

FIG. 3A illustrates a flow diagram of an example method of generating electronic digital messages that carry state metadata for virtual reality environments and values indicating levels of comfort in experiencing virtual reality environments. FIG. 3B illustrates other steps in the example of FIG. 3A. FIG. 4 illustrates a flow diagram of an example method of generating analytics data based upon state metadata for virtual reality environments and associated or correlated values indicating levels of comfort in experiencing virtual reality environments. FIG. 5 is a block diagram of an example computer system with which embodiments can be used, focused on functional elements and data structures that may be configured or programmed to generate messages and analytics data based upon state metadata for virtual reality environments and associated or correlated values indicating levels of comfort in experiencing virtual reality environments.

FIG. 3A, FIG. 3B, and each other flow diagram in this disclosure, is intended as an example of a programmable algorithm that may be implemented using one or more of the application publisher computing device(s) 160 and virtual reality analytics system 170 under control of one or more computer programs that are configured to execute the operations that are described in connection with the flow diagrams. The programs may be created using any computer program development environment that is now known or contemplated at the time of this writing, including but not limited to JAVA, C++, OBJECTIVE-C, C, C#, PASCAL, alone or in combination with scripting languages such as PERL, JAVASCRIPT and the like. The programs, alone or in combination, may contain source language instructions, pseudo-code, and/or machine language instructions which when executed cause performing a computer-implemented method comprising:
during execution of a virtual reality program by a client computer that causes generating and displaying a virtual reality environment via a virtual reality display device that is coupled to the client computer, by a set of comfort level processing instructions, receiving a programmatic call from the virtual reality program that invokes comfort level processing;
by the comfort level processing instructions, generating and causing the client computer to display a prompt panel within the virtual reality environment that prompts selecting a comfort value indicating a relative level of user comfort associated with the virtual reality environment;
by the comfort level processing instructions, receiving an input signal indicating a selection of the comfort value;
creating in memory of the client computer, by the comfort level processing instructions, a digital message that includes the comfort value, one or more names of metadata attributes associated with the virtual reality environment, and one or more metadata values corresponding to the names of metadata attributes and indicating one or more aspects of a state of the virtual reality environment at a time that the digital message is created;
transmitting the digital message from the client computer to a server computer over a data network.
determining that the comfort value is less than or equal to a specified minimum comfort level, and in response, generating and causing the client computer to display a second prompt panel within the virtual reality environment that prompts selecting one or more detailed items relating to discomfort, receiving a second input signal indicating a second selection of a particular one of the detailed items, and creating in memory of the client computer, by the comfort level processing instructions, the digital message that includes the comfort value, the particular one of the detailed items, the one or more names of metadata attributes associated with the virtual reality environment, and the one or more metadata values corresponding to the names of metadata attributes and indicating the one or more aspects of the state of the virtual reality environment at the time that the digital message is created.
receiving a programmatic call from the virtual reality program that requests registering the one or more names of metadata attributes associated with the virtual reality environment, and in response, transmitting a registration request from the client computer to the server computer over the data network which when processed by the server computer causes the server computer to create and store a table in a database having columns corresponding to the one or more names of metadata attributes associated with the virtual reality environment.
storing in a database a record having a key value that uniquely identifies the virtual reality environment and that associates, with the key value, the comfort value, the one or more names of metadata attributes associated with the virtual reality environment, and the one or more metadata values corresponding to the names of metadata attributes that were received in the digital message.
receiving a search query specifying one or more particular comfort values; by the server computer, searching a database for records associated with a particular virtual reality environment and having key values that match the one or more particular comfort values in the search query; by the server computer, automatically generating one or more of graphs, charts or statistical reports that correlate the one or more particular comfort values to each of the names of the metadata attributes without requiring explicit input of one or more of the names of the metadata attributes.
identifying, to an application publisher computing device, reserved virtual reality locations in one or more parameters for the virtual reality environment; by the comfort level processing instructions, causing displaying the prompt panel only in the reserved virtual reality locations in the virtual reality environment.
causing displaying the prompt panel only after the virtual reality program reaches a transition point.
causing displaying the prompt panel only after the virtual reality program reaches a change in levels of a game.
the foregoing operations in which a particular name of one of the metadata attributes is for an event that occurred in the virtual reality environment since a last time that a metadata value corresponding to that particular name was updated.

For purposes of illustrating a clear example, FIG. 3A, FIG. 3B, and FIG. 4 will be described in the context of a networked computer system such as that shown in the example of FIG. 5. In the embodiment of FIG. 5, client computing device 110 comprises analytics support instructions 502, which may be integrated within the particular application 120 or linked to it. When linking is used, for example, the application publisher computing device 160 may download a software development kit (SDK) from the VR analytics system 170 and then compile and link the SDK with the particular application 120. The analytics support instructions 502 are programmed, in general, to support definition of a plurality of metadata names 508 relating to aspects of the ongoing state of the particular application 120 or the generated virtual environment 130, and to cause the particular application to output metadata values 510 at the time that the particular application is executing. When a particular one of the metadata values 510 is generated at the time that the particular application 120 is executing and thus represents some value pertaining to an aspect of real-time, live or current state, it is termed a then-current metadata value.

In general, analytics support instructions 502 are programmed to respond to calls from the particular application 120 to generate prompt messages within the generated virtual reality environment 130, to obtain input from the client computing device 110 that is associated with a then-current level of comfort of the user within the VR environment, to obtain then-current metadata values 510 for the attributes indicated in the metadata names 508, and to form an analytics message 512 that can be given to a server computer 172 for analysis. In an embodiment, the analytics support instructions 502 are programmed to cause generating and displaying a first-level comfort prompt 504 within the generated VR environment 130. In an embodiment, the analytics support instructions 502 also are programmed to cause generating and displaying a second-level comfort prompt 506 within the generated VR environment 130. The use of the prompts is further described in other sections herein.

A call from the particular application 120 to the analytics support instructions 502, and therefore generating the first-level prompt 504, may occur at any time during execution of the particular application. Examples of appropriate times to call analytics support instructions 502 include completion of the particular application 120, a change in virtual levels within the generated VR environment 130, a significant event occurring within the VR environment, etc. However, a benefit of the approaches herein is that a publisher of the particular application 120 and/or the VR environment 130 has complete flexibility to define what the metadata names 508 are, and when the analytics support instructions 502 are called.

As seen in FIG. 5, client computing device 110 is coupled via network 100 to the server computer 172, which is programmed with analytics instructions that may be configured to perform the operations of FIG. 4. Typically, server computer 172 is coupled to a database 520, which is programmed with tables or other storage structures that are capable of holding data records. In an embodiment, each record in database 520 has at least one key field that is associated and/or populated with identifiers of applications or VR environments, for example, particular application 120 and generated VR environment 130. Columns in these records specify comfort level values that are obtained via the first-level comfort prompt 504 and second-level comfort prompt 506, and metadata values 510, which may be received via analytics messages 512.

Referring now to FIG. 3A, at step 302, the process of FIG. 3A receives definitions of a plurality of metadata names. The metadata names typically define attributes or elements of the state of a VR environment. The metadata names are defined by a publisher of the VR environment, such as application publisher computing device 160, and may relate to any aspect of operation of the VR environment. Optionally, step 302 may comprise transmitting the metadata names to a database, such as database 520 of FIG. 5, for storing in association with an identifier of a particular publisher and virtual reality (VR) environment, and thus step 302 can comprise a process of registering the defined metadata names 508 with the database 520 before the server computer 172 performs analytics operations. Registration can comprise forming a table in the database 520 for the specified publisher or VR environment or for the particular application 120, with columns for an identifier field, one or more comfort level values, and one or more metadata values 510 that correspond to the registered metadata names.

At step 304, the generated VR environment initiates operation. Step 304 may represent launching the particular application 120, which causes generating and rendering the generated VR environment 130 using a VR display device, such as the HMD of FIG. 2.

At step 306, the process receives a programmatic call that invokes comfort level processing. For example, particular application 120 issues a programmatic call to a function of the SDK code that implements the analytics support instructions 502, so those instructions receive the call. In response, at step 308, the process causes generating and displaying a first-level prompt panel within the VR environment that prompts the user to select a value indicating a relative level of comfort. For example, a first-level comfort prompt 504 of the format seen in FIG. 5 may be displayed. As a specific example, within the generated VR environment 130, a graphical panel is displayed containing the text: “How do you feel in this experience? Select Great, Good, OK, Uncomfortable, Severely Uncomfortable.” In an embodiment, the analytics support instructions 502 are programmed to cause displaying terms such as “Great, Good, OK, Uncomfortable, Severely Uncomfortable” as graphically selectable options that can be selected using input from the HIVID, for example. All aspects of this text, including the prompt or query and the selectable options, may vary in different embodiments and the particular text, message, prompt or query, and the name or text used for the options, are not critical. In some embodiments, the selectable items are displayed as icons or graphical images, for example, face images or icons, and text is not used. Existing graphical drawing library functions or VR environment rendering functions can be used to instantiate a visual graphical panel that appears within the VR environment, such as centered in the HMD's field of view, and to draw text in the panel.

At step 310, the process receives selection input and stores the corresponding value as a first-level comfort value. For example, step 310 may represent receiving input from client computing device 110 via an I/O device such as the HMD of FIG. 2, and transiently storing in memory a numeric value corresponding to one of the selectable options, such as “Great, Good, OK, Uncomfortable, Severely Uncomfortable.”

At step 312, the process tests whether the value that was obtained via the selection input is below a specified or stored minimum comfort value. For example, if the selection input received at step 310 indicates “Uncomfortable” or “Severely Uncomfortable,” then the result of step 312 would be Y, YES or TRUE. In contrast, if the selection input received at step 310 indicates “Great,” “Good,” “OK”, then the result of step 312 would be N, NO or FALSE.

Control transfer to step 314 when the result of step 312 is Y, YES or TRUE. In an embodiment, at step 314, the process generates and causes displaying a second-level prompt panel within the VR environment that prompts the user to select more detailed items relating to discomfort. As seen in FIG. 5, a second-level comfort panel could be structured to display a message such as “Do you feel Bored, Nauseous, Tired” where each of “Bored, Nauseous, Tired” is a separately selectable response option. The particular selectable response options of the second level may vary based upon the particular first-level response value that was received, so the analytics support instructions 502 may be programmed to branch or switch to different subroutines or methods to present different second-level options depending on the value of the first-level response input. In some embodiments, the selectable items are displayed as icons or graphical images, for example, face images, and text is not used.

In an embodiment, as with step 310, step 314 may include receiving a selection input for one of the second-level options that was presented at step 314, and storing the second-level selection input as a second-level comfort value.

In some embodiments, the first-level comfort value selections, and/or the second-level comfort value selections, are defined by the application publisher computing device 160 or developer of the particular application 120 or generated VR environment 130. For purposes of illustrating a clear example, five (5) comfort level choices are shown in some embodiments herein, but other embodiments may have more or fewer.

At step 316, the process determines values for each of the defined metadata names, based on the current state of the VR environment; generates a message payload containing name-value pairs for the metadata names, current values, the first-level comfort value and the second-level comfort value if present. In an embodiment, step 316 may be implemented by programming the analytics support instructions to create and store metadata values 510 corresponding to each of the metadata names 508. The values may be obtained by polling the particular application 120, calling services of the operating system of client computing device 110, calling routines of the operating system of the HIVID of FIG. 2, or using dedicated code in the analytics support instructions. As one example, analytics support instructions 502 may implement wrapper code for metadata value functions that the publisher of the particular application 120 is expected to implement in code that is compatible with the publisher application and compile as part of the executable. For example, if the analytics support instructions 502 specifies a wrapper for a function having the nature “return the current level of the game,” then the particular application 120 is expected to implement code that can obtain a current level value from storage or memory that the particular application is managing, or a variable or constant that is managed as part of its code, and return that value in the implementation of the function. The resulting message payload may be incorporated in the analytics message 512 seen in FIG. 5.

Further, in describing step 316, the term “name-value pair” is given as an example of data representation of the metadata names 508 and metadata values 510, but in other embodiments, other data representation formats may be used. For example, the metadata values may be placed in a message payload or message body as an ordered list, or indexed vector, without explicitly providing the names that correspond to the values.

After step 316, control continues using the steps shown in FIG. 3B. In an embodiment, at step 320, a digital electronic message, which includes the message payload that was prepared at step 316, is transmitted from the VR system to a server computer that is programmed with analytics instructions. For example, the analytics support instructions 502 are programmed to generate the analytics message 512 seen in FIG. 5 and forward it via network 100 toward server computer 172.

At step 322, in an embodiment, in response to receiving the analytics message 512, the server computer 172 is programmed to store, in a database such as database 520, a record having a key value that identifies the VR environment, and that associates the content of the message payload with the key value.

In any of the foregoing embodiments, the metadata values 510 may reflect any aspects or attributes of the state of a virtual reality experience or environment that the application publisher computing device 160 has specified or deemed important or useful. Examples include: virtual level in a game; status of the user or client computing device 110; duration of use of the VR experience or duration of play of a game; data specific to a particular experience, for example, data for racing game could comprise average g-force around turns, collisions with walls, average speed over a specified period. In some embodiments, the metadata values 510 may comprise a snapshot of all state values that the particular application 120 maintains as part of normal operation. Metadata values 510 may represent major events in the VR experience that occurred recently and that could contribute to the comfort level response. Moreover, the metadata values 510 can include data that is not specified by the client computing device 110, server or publisher such as amount of time elapsed in playing or using a particular application 120, VR experience or generated VR environment 130.

4. Analytics Processing

The process of FIG. 3A, FIG. 3B may be repeated any number of times by the particular application 120 or VR environment 130, either at different times, intervals or events during the same instance of execution with the same client computing device 110, or across many different instances of execution with different client computers, again at different times, intervals or events during those instances of execution. Over time, then, the database 520 builds a set of many records, including thousands or millions, that indicate the comfort level of different users in the same VR experience, at different states of that experience. Based on this data, the application publisher computing device 160 can acquire powerful analytical data about the effect that the particular application 120 is having on users, individually or in the aggregate.

Based on the foregoing, the processes disclosed herein provide a computer-implemented method by which a particular VR application, which manages a generated VR environment 130, can use analytics support instructions to cause prompting the client computing device with one or more levels of prompts, at publisher-specified intervals in the environment, which induce the client computing device to provide input indicating levels of user comfort at those intervals; the input then may be associated in real time with data values indicating a then-current state of the VR environment or application at the time that the comfort level input was received, and the resulting state data plus the comfort level values and an identifier of the application or VR environment and device may be associated in a database automatically for later analysis.

Referring now to FIG. 4, a process of performing server-side computer analysis. At step 402, the process initiates operation of analytics instructions in a server computer. For example, server computer 172 may initiate operation of an analytics package, method, program or interface.

At step 404, the process determines a particular virtual reality environment identifier, for example, based upon an identifier that is associated with a particular publisher application, or other input specifying a particular VR environment. For example, one of the client computers of FIG. 1 may comprise an administrator computer associated with an employee, developer or administrator who is affiliated with the application publisher computing device 160. That client computer may log in, using a web browser at the client computer, to a web server application at the server computer 172 that implements an analytics application, by providing valid credentials, such as a user name and password. The server computer 172 may store, in database 520, a table that maps user credentials to identifiers of particular publishers, applications 120, or VR environments 130. By using the mapping in response to receiving login credentials to look up one or more particular publishers, applications 120, or VR environments 130, the server computer 172 may be programmed to associate a particular connection to a browser or client computer with a particular table, range, or instance of comfort level data that is relevant to one or more particular publishers, applications 120, or VR environments 130.

At step 405, the process receives a query specifying one or more particular first-level comfort values. For example, the client computer associated with a publisher may enter a search query indicating “Severely Uncomfortable” for a VR experience titled “Virtual Drag Racing 280”. In response, at step 406, in an embodiment the process searches the database for records that are associated with that particular VR environment, and having key values matching the one or more particular first-level comfort values, which is “Severely Uncomfortable” in this example. The result of the query and search will be a result set of all records where client computing devices 110 of VR environment users reported “Severely Uncomfortable” at any state of “Virtual Drag Racing 280”.

At step 408, based on a result set of records that have been found based on the query and the search, the process generates a graph, chart or statistical report that correlates the one or more particular first-level comfort values to the one or more metadata values that have been stored in the records of the result set. At step 410, the process causes displaying the graph, chart or statistical report on a client computing device, for example, by generating a dynamic HTML page and returning it to the requesting browser.

Statistical reports can indicate, for example, for a particular comfort level, or for a change from one comfort level to another, what the game state was. Reports, graphs or charts may indicate when transitions in comfort level occur within a particular VR experience by specifying a virtual location, level, event or other status value at which comfort level values obtained from client computing devices 110 suddenly change or vary significantly.

Reports also can specify metadata values that relate to one specific comfort level value. For example, in response to query input specifying a discrete value for the first-level comfort value such as “Good” or “3”, a report may provide a summary of metadata values 510 from the database 510 for all users or client computing devices 110 that reported the specified first-level comfort value. The metadata values 510 may be reported as mean values, arithmetic averages, a range within one standard deviation from the mean, etc. Still other reports may show, for example, what percentage of the time incurred using a particular VR experience (or play time) occurred when the client computing device 110 or user was below a specified comfort level.

In an embodiment, the process generates aggregate reports from the set of records indicating comfort levels of different users in the same or different applications. By generating aggregate reports across different applications, the process is able to display comparisons between comfort levels of a particular application and other applications. For example, a report may depict an average comfort level of a particular application, an average comfort level of applications in the same genre as the particular application, and an average comfort level of applications generally.

In an embodiment, aggregate reports include reports comparing a plurality of applications. For example, an aggregate report may list average comfort scores for each genre of application, average comfort scores for each date, and/or percentages of comfort scores relating to different explanations for the comfort scores. For example, a second-level prompt may request a selection of a reason for selecting a particular comfort level. The aggregate reports may include chart and/or graph which depicts a percentage of comfort scores associated with each response of the second level feedback prompt.

In an embodiment, aggregate reports include aggregate analytic information. A report for a particular application may depict average comfort scores for different metadata values, such as portion of the application or actions undertaken in the application prior to the selection of the comfort level. For example, a sample aggregate report may indicate the number of selections of each level of comfort and average comfort scores during the tutorial, the first level, the second level, etc. An aggregate report may depict comfort levels broken down by session length in order to display the effects of longer play on comfort for a particular application. Additionally and/or alternatively, the aggregate reports may depict comfort levels broken down by date. This allows an application publisher to understand the effects of updates of the application to general comfort levels.

5. Implementation Example—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

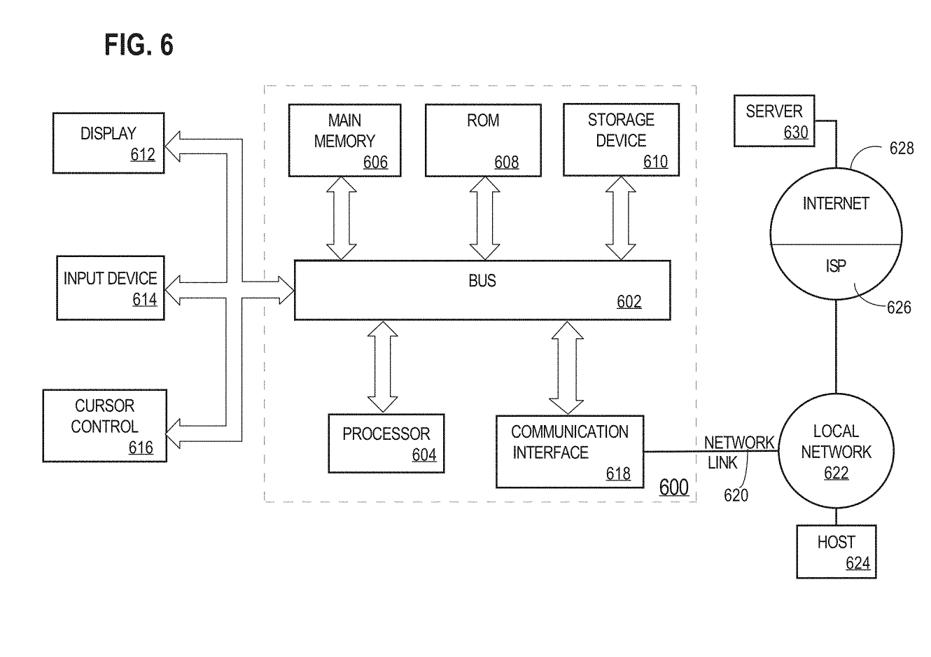

For example, FIG. 6 is a block diagram that illustrates a computer system 600 upon which an embodiment may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A computer-implemented method comprising:
during execution of a virtual reality program by a client computer that causes generating and displaying a virtual reality environment via a virtual reality display device that is coupled to the client computer, by a set of comfort level processing instructions, receiving a programmatic call from the virtual reality program that invokes comfort level processing;
by the comfort level processing instructions, generating and causing the client computer to display a prompt panel within the virtual reality environment that prompts selecting a comfort value indicating a relative level of user comfort associated with the virtual reality environment;
by the comfort level processing instructions, receiving an input signal indicating a selection of the comfort value;
creating in memory of the client computer, by the comfort level processing instructions, a digital message that includes the comfort value, one or more names of metadata attributes associated with the virtual reality environment, and one or more metadata values corresponding to the names of metadata attributes and indicating one or more aspects of a state of the virtual reality environment at a time that the digital message is created;
transmitting the digital message from the client computer to a server computer over a data network.

2. The method of claim 1 further comprising, by the comfort level processing instructions, determining that the comfort value is less than or equal to a specified minimum comfort level, and in response, generating and causing the client computer to display a second prompt panel within the virtual reality environment that prompts selecting one or more detailed items relating to discomfort, receiving a second input signal indicating a second selection of a particular one of the detailed items, and creating in memory of the client computer, by the comfort level processing instructions, the digital message that includes the comfort value, the particular one of the detailed items, the one or more names of metadata attributes associated with the virtual reality environment, and the one or more metadata values corresponding to the names of metadata attributes and indicating the one or more aspects of the state of the virtual reality environment at the time that the digital message is created.

3. The method of claim 1 further comprising, by the comfort level processing instructions, receiving a programmatic call from the virtual reality program that requests registering the one or more names of metadata attributes associated with the virtual reality environment, and in response, transmitting a registration request from the client computer to the server computer over the data network which when processed by the server computer causes the server computer to create and store a table in a database having columns corresponding to the one or more names of metadata attributes associated with the virtual reality environment.

4. The method of claim 1, further comprising, by the server computer, storing in a database a record having a key value that uniquely identifies the virtual reality environment and that associates, with the key value, the comfort value, the one or more names of metadata attributes associated with the virtual reality environment, and the one or more metadata values corresponding to the names of metadata attributes that were received in the digital message.

5. The method of claim 1, further comprising:
by the server computer, receiving a search query specifying one or more particular comfort values;
by the server computer, searching a database for records associated with a particular virtual reality environment and having key values that match the one or more particular comfort values in the search query;
by the server computer, automatically generating one or more of graphs, charts or statistical reports that correlate the one or more particular comfort values to each of the names of the metadata attributes without requiring explicit input of one or more of the names of the metadata attributes.

6. The method of claim 1, further comprising:
identifying, to an application publisher computing device, reserved virtual reality locations in one or more parameters for the virtual reality environment;
by the comfort level processing instructions, causing displaying the prompt panel only in the reserved virtual reality locations in the virtual reality environment.

7. The method of claim 1, further comprising, by the comfort level processing instructions, causing displaying the prompt panel only after the virtual reality program reaches a transition point.

8. The method of claim 1 further comprising, by the comfort level processing instructions, causing displaying the prompt panel only after the virtual reality program reaches a change in levels of a game.

9. The method of claim 1 wherein a particular name of one of the metadata attributes is for an event that occurred in the virtual reality environment since a last time that a metadata value corresponding to that particular name was updated.

10. A virtual reality analytics system comprising:
one or more hardware processors;
a digital electronic memory that is communicatively coupled to the one or more hardware processors and programmed to perform:
during execution of a virtual reality program by a client computer that causes generating and displaying a virtual reality environment via a virtual reality display device that is coupled to the client computer, by a set of comfort level processing instructions, receiving a programmatic call from the virtual reality program that invokes comfort level processing;
by the comfort level processing instructions, generating and causing the client computer to display a prompt panel within the virtual reality environment that prompts selecting a comfort value indicating a relative level of user comfort associated with the virtual reality environment;
by the comfort level processing instructions, receiving an input signal indicating a selection of the comfort value;
creating in memory of the client computer, by the comfort level processing instructions, a digital message that includes the comfort value, one or more names of metadata attributes associated with the virtual reality environment, and one or more metadata values corresponding to the names of metadata attributes and indicating one or more aspects of a state of the virtual reality environment at a time that the digital message is created;
transmitting the digital message from the client computer to a server computer over a data network.

11. The virtual reality analytics system of claim 10 further comprising comfort level processing instructions which when executed cause determining that the comfort value is less than or equal to a specified minimum comfort level, and in response, generating and causing the client computer to display a second prompt panel within the virtual reality environment that prompts selecting one or more detailed items relating to discomfort, receiving a second input signal indicating a second selection of a particular one of the detailed items, and creating in memory of the client computer, by the comfort level processing instructions, the digital message that includes the comfort value, the particular one of the detailed items, the one or more names of metadata attributes associated with the virtual reality environment, and the one or more metadata values corresponding to the names of metadata attributes and indicating the one or more aspects of the state of the virtual reality environment at the time that the digital message is created.

12. The virtual reality analytics system of claim 10 further comprising comfort level processing instructions which when executed cause receiving a programmatic call from the virtual reality program that requests registering the one or more names of metadata attributes associated with the virtual reality environment, and in response, transmitting a registration request from the client computer to the server computer over the data network which when processed by the server computer causes the server computer to create and store a table in a database having columns corresponding to the one or more names of metadata attributes associated with the virtual reality environment.

13. The virtual reality analytics system of claim 10, further comprising instructions executed by the server computer which when executed cause storing in a database a record having a key value that uniquely identifies the virtual reality environment and that associates, with the key value, the comfort value, the one or more names of metadata attributes associated with the virtual reality environment, and the one or more metadata values corresponding to the names of metadata attributes that were received in the digital message.

14. The virtual reality analytics system of claim 10, further comprising instructions executed by the server computer which when executed cause:
receiving a search query specifying one or more particular comfort values;
searching a database for records associated with a particular virtual reality environment and having key values that match the one or more particular comfort values in the search query;
automatically generating one or more of graphs, charts or statistical reports that correlate the one or more particular comfort values to each of the names of the metadata attributes without requiring explicit input of one or more of the names of the metadata attributes.

15. The virtual reality analytics system of claim 10, further comprising instructions executed at the server computer which when executed cause performing:
identifying, to an application publisher computing device, reserved virtual reality locations in one or more parameters for the virtual reality environment;
by the comfort level processing instructions, causing displaying the prompt panel only in the reserved virtual reality locations in the virtual reality environment.

16. The virtual reality analytics system of claim 10, further comprising comfort level processing instructions which when executed cause displaying the prompt panel only after the virtual reality program reaches a transition point.

17. The virtual reality analytics system of claim 10 further comprising comfort level processing instructions which when executed cause displaying the prompt panel only after the virtual reality program reaches a change in levels of a game.

18. The virtual reality analytics system of claim 10 wherein a particular name of one of the metadata attributes is for an event that occurred in the virtual reality environment since a last time that a metadata value corresponding to that particular name was updated.
